(19) United States
(12) Patent Application Publication
(10) Pub. No.: US 2011/0217859 A1
(43) Pub. Date: Sep. 8, 2011

(54) Waterproof connector that can be designed to be short in overall length

(75) Inventor: Akinori Kimura, Tokyo (JP)

(73) Assignee: Japan Aviation Electronics Industry, Limited, Tokyo (JP)

(21) Appl. No.: 12/931,430

(22) Filed: Feb. 1, 2011

(30) Foreign Application Priority Data
Mar. 5, 2010 (JP) 2010-048809

(51) Int. Cl. H01R 13/52

(52) U.S. Cl. 439/271

(57) ABSTRACT

A retainer is incorporated into a fitting portion of a housing so as to be movable between a preset position and a set position in a direction crossing terminal receiving holes. Further, a seal member is attached to an outer periphery of the fitting portion. The seal member is brought into close contact with an inner periphery of a fitting hole of a mating connector for sealing when the fitting portion is fitted to the fitting hole. The retainer has projections which retreat to the sides of the terminal receiving holes to allow insertion of terminals into the terminal receiving holes when the retainer is at the preset position and which project into the terminal receiving holes to engage with the terminals so as to hold the terminals in a come-off preventing state when the retainer is at the set position. The retainer and the seal member are provided at positions which overlap each other in a direction of fitting to the mating connector.

This application is based upon and claims the benefit of priority from Japanese patent application No. 2010-048809, filed on Mar. 5, 2010, the disclosure of which is incorporated herein in its entirely by reference.

### TECHNICAL FIELD

This invention relates to a waterproof connector and, in particular, relates to a waterproof connector that locks terminals using a retainer which is movable in a direction crossing terminal receiving holes.

### BACKGROUND ART

JP-A-2000-173709 (Patent Document 1) discloses a waterproof connector of this type. The disclosed waterproof connector will be briefly described with reference to FIG. 1. A seal ring 3 is fitted over an outer periphery of a housing body 1 at a rear end of a hood portion 2 which is provided around the housing body 1 on its front end 1a side. A retainer insertion groove 4 is formed in a side surface of the housing body 1 in front of the fitting position of the seal ring 3. A retainer 5 is inserted into the retainer insertion groove 4 through a window hole (not illustrated) which is opened in a side surface of the hood portion 2 at a position corresponding to the retainer insertion groove 4. The retainer 5 is held at a temporary locking position where the retainer 5 allows insertion and removal of terminal metal fittings 6A and 6B and at a real locking position where the retainer 5 locks into recessed portions 7 of the terminal metal fittings 6A and 6B, respectively. Operation of the retainer 5 is carried out from the front side of the housing body 1.

### SUMMARY OF THE INVENTION

In the waterproof connector disclosed in Patent Document 1, the retainer insertion position is located forward of a sealing surface provided by the seal ring 3. That is, the retainer insertion groove 4 is located forward of the seal ring 3 and, further, the window hole is formed corresponding to the retainer insertion groove 4. With such a structure in which the retainer insertion position and the sealing surface are offset in the front-rear direction, i.e. in a direction of fitting to a mating connector, it is not possible to avoid an increase in overall length of the waterproof connector.

It is therefore an exemplary object of this invention to provide a waterproof connector that solves the above-mentioned problem.

Other objects of the present invention will become clear as the description proceeds.

According to an aspect of the present invention, there is provided a waterproof connector comprising a housing including a fitting portion which is adapted to be fitted into a fitting hole of a mating connector in a fitting direction, the fitting portion having a terminal receiving hole which penetrates the fitting portion in the fitting direction, a terminal to be received in the terminal receiving hole, a retainer which is assembled in the fitting portion so as to be movable between a preset position and a set position in a direction crossing the terminal receiving hole, and a seal member which is attached to an outer periphery of the fitting portion and is adapted to be brought into close contact with an inner periphery of the fitting hole for sealing when the fitting portion is fitted to the fitting hole, wherein the retainer has a projection which retreats to a side of the terminal receiving hole to allow insertion of the terminal into the terminal receiving hole when the retainer is at the preset position and which projects into the terminal receiving hole to engage with the terminal so as to hold the terminal in the terminal receiving hole when the retainer is at the set position, and the retainer and the seal member are provided at positions which overlap each other in the fitting direction.

### BRIEF DESCRIPTION OF THE DRAWINGS

FIG. 1 is a cross-sectional view for explaining a waterproof connector disclosed in Patent Document 1 (JP-A-2000-173709);

FIG. 2 is an overall perspective view showing a waterproof connector according to an embodiment of this invention in a cable connected state;

FIG. 3 is an exploded perspective view showing the waterproof connector of FIG. 2 with terminals removed;

FIG. 4A is a perspective view, as seen from the left, of a housing of the waterproof connector of FIG. 2;

FIG. 4B is an enlarged view of a portion B in FIG. 4A;

FIG. 5 is a perspective view, as seen from the rear, of a retainer included in the waterproof connector of FIG. 2;

FIG. 6 is a front view of a state where the retainer is incorporated in the housing;

FIG. 7A is a longitudinal cross-sectional view of a state before the retainer is incorporated into the housing, for explaining the incorporation of the retainer into the housing;

FIG. 7B is a longitudinal cross-sectional view of a state after the retainer is incorporated into the housing, for explaining the incorporation of the retainer into the housing, wherein the retainer is at a preset position;

FIG. 8A is a side view of a state before a front cap is incorporated into the housing, for explaining the incorporation of the front cap into the housing, wherein the retainer is at the preset position;

FIG. 8B is a longitudinal cross-sectional view of a state after the front cap is incorporated into the housing, for explaining the incorporation of the front cap into the housing, wherein the retainer is at the preset position;

FIG. 9 is a longitudinal cross-sectional view of the waterproof connector of FIG. 2, wherein the retainer is at the preset position;

FIG. 10A is a front view of a state where the retainer of the waterproof connector of FIG. 2 is at the preset position;

FIG. 10B is a cross-sectional view taken along line Xb-Xb in FIG. 10A,

FIG. 11A is a front view of a state where the retainer of the waterproof connector of FIG. 2 is at a set position;

FIG. 11B is a cross-sectional view taken along line XIb-XIb in FIG. 11A;

FIG. 12A is a partly sectioned perspective view of a state where the retainer of the waterproof connector of FIG. 2 is at the preset position;

FIG. 12B is an enlarged view of a portion B in FIG. 12A;

FIG. 12C is an enlarged view of a portion C in FIG. 12A;

FIG. 13A is a partly sectioned perspective view of a state where the retainer of the waterproof connector of FIG. 2 is on the way from the preset position to the set position;

FIG. 13B is an enlarged view of a portion B in FIG. 13A;

FIG. 13C is an enlarged view of a portion C in FIG. 13A;

FIG. 14A is a partly sectioned perspective view of a state after the retainer of the waterproof connector of FIG. 2 is moved to the set position;

FIG. 14B is an enlarged view of a portion B in FIG. 14A;

FIG. 14C is an enlarged view of a portion C in FIG. 14A;

FIG. 15 is a longitudinal cross-sectional view of a state before fitting of the waterproof connector of FIG. 2 to a mating connector, wherein the retainer is at the set position;

FIG. 16 is a longitudinal cross-sectional view of a state after fitting of the waterproof connector of FIG. 2 to the mating connector, wherein the retainer is at the set position;

FIG. 17A is a perspective view of a housing for explaining a modification of a retainer positioning mechanism;

FIG. 17B is an enlarged view of a portion B in FIG. 17A;

FIG. 17C is a perspective view of a retainer; and

FIG. 17D is an enlarged view of a portion D in FIG. 17C.

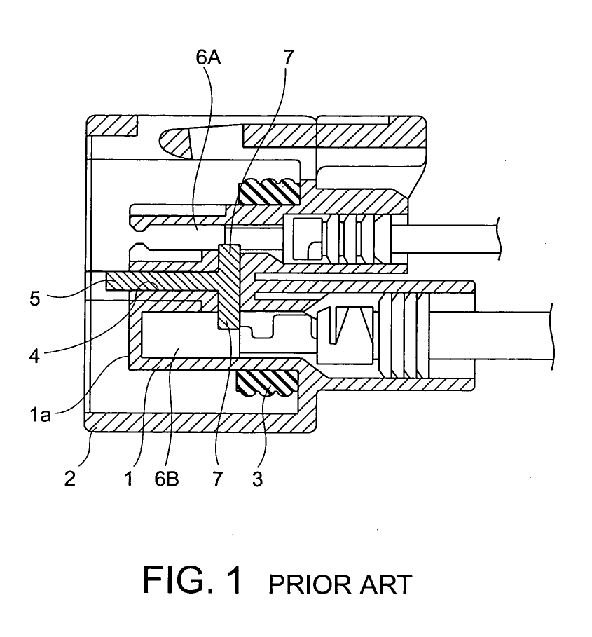

### DESCRIPTION OF THE EMBODIMENTS

With reference to the drawings, description will be made as regards a waterproof connector according to an exemplary embodiment of this invention.

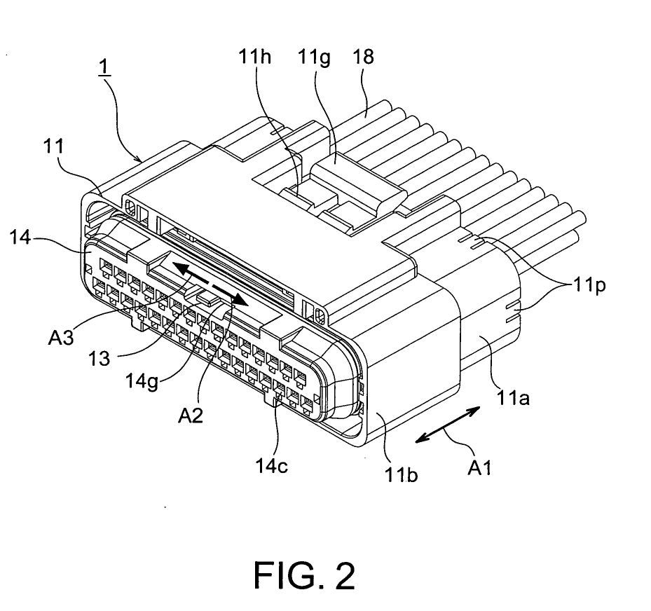

Referring to FIGS. 2, 3, and 15, the waterproof connector is generally designated by numeral 1 and comprises a housing 11, a seal member 12, a retainer 13, a front cap 14, a cable seal member 15, a rear cover 16, and a plurality of terminals 17. The housing 11, the retainer 13, the front cap 14, and the rear cover 16 are made of synthetic resin, the seal member 12 and the cable seal member 15 are made of rubber, and the terminals 17 are made of metal.

The housing 11 has a connector body 11a of a laterally long rectangular parallelepiped shape in which terminal receiving holes 11d each penetrating in a front-rear direction A1 are arranged side by side in two, upper and lower, rows and further has a hood portion 11b formed so as to surround the connector body 11a on its front end side. The front end side portion, surrounded by the hood portion 11b, of the connector body 11a forms a fitting portion 11c which is adapted to be fitted to a mating connector 2. The connector body 11a has a rear end face formed with a cable seal member mounting recess 11n. The cable seal member mounting recess 11n is formed over the entirety of the rear end face except at its peripheral portion and the terminal receiving holes 11d are opened at the bottom of the cable seal member mounting recess 11n.

A stepped-down mounting portion 11f is formed on an outer periphery of the fitting portion 11c on its front end side and the annular seal member 12 is tightly mounted around the seal member mounting portion 11f. Further, a locking arm 11g is formed so as to extend rearward from an upper surface of the fitting portion 11c. An upper wall portion of the hood portion 11b is bulged upward so as to surround the locking arm 11g.

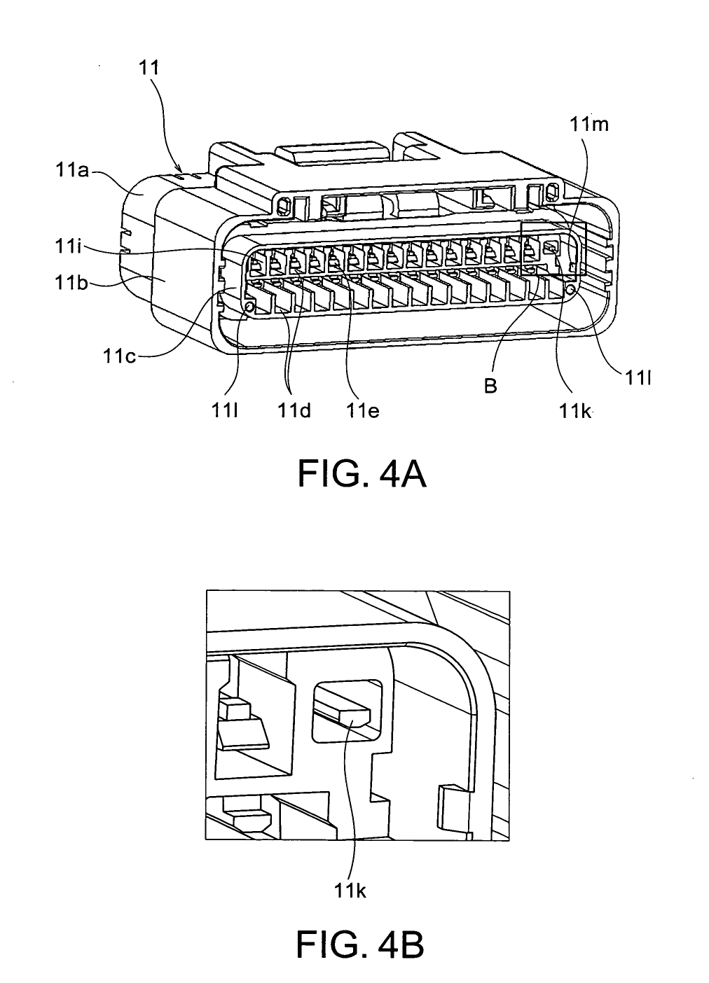

Referring further to FIGS. 4A and 4B, a retainer mounting recess portion 11i for mounting the retainer 13 is formed at an upper half of a front end face of the fitting portion 11c except at its peripheral portion. The upper-row terminal receiving holes 11d are opened at the bottom of the retainer mounting recess portion 11i. The lower-row terminal receiving holes 11d extend to the front end face of the fitting portion 11c while their top portions are opened at an inner periphery of the retainer mounting recess portion 11i.

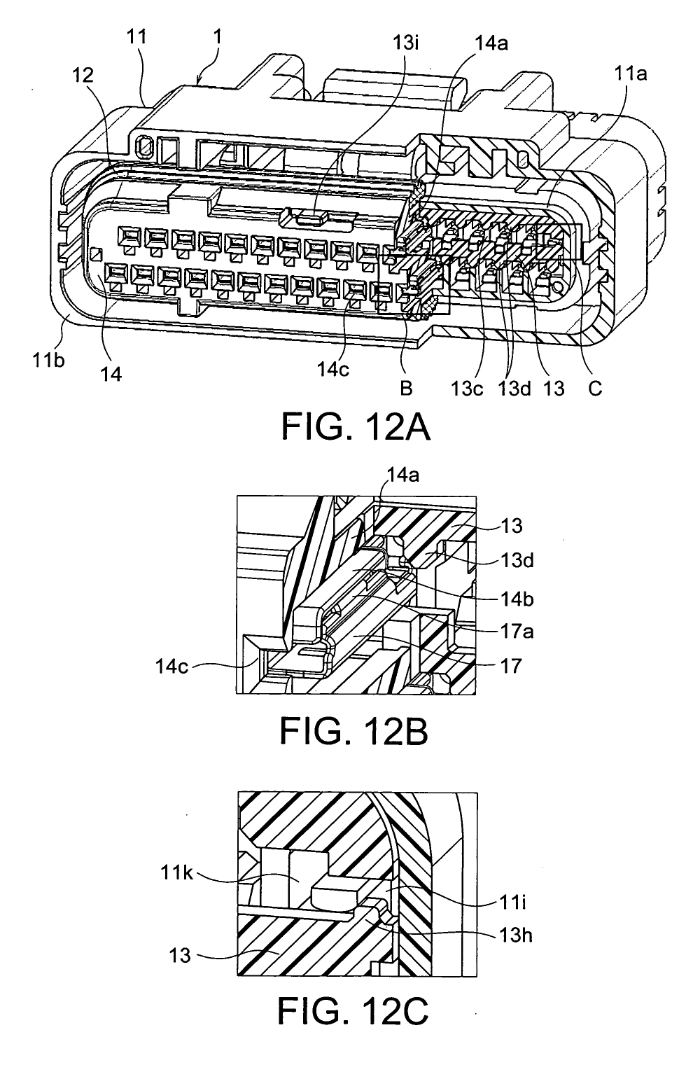

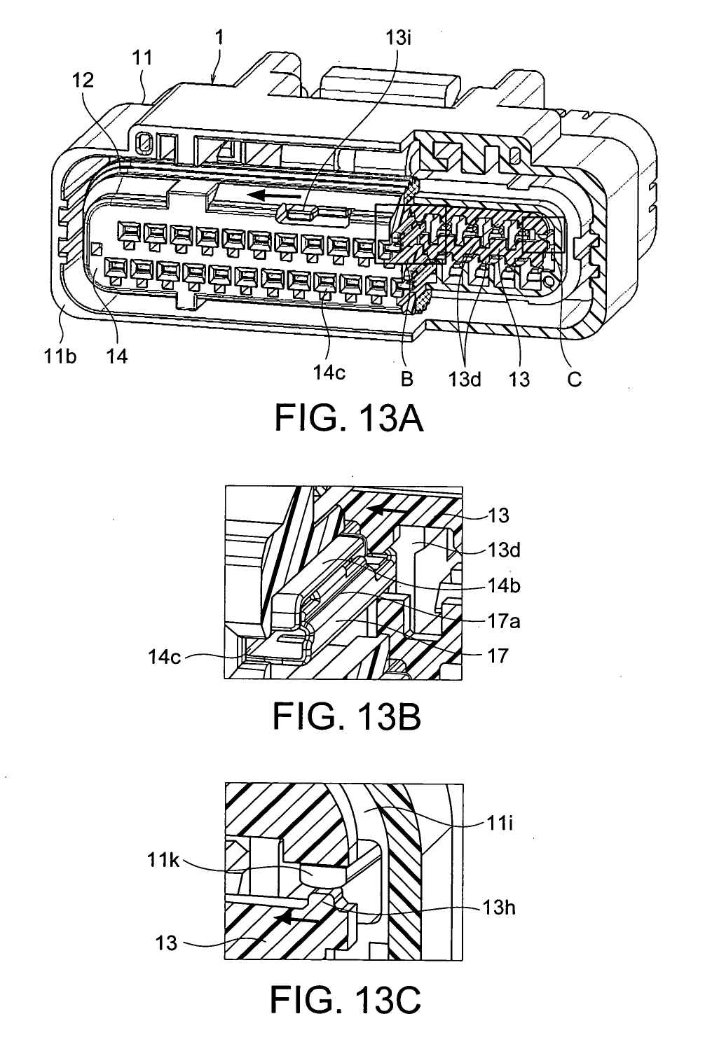

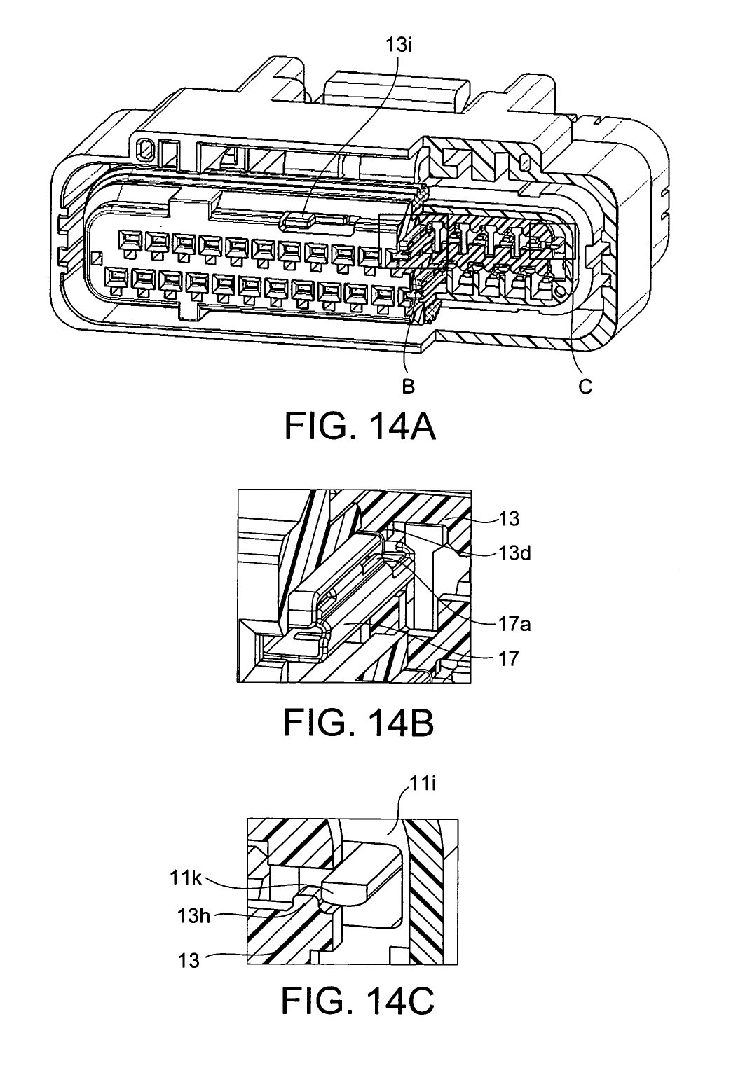

As shown in FIGS. 6 and 10A to 14C, the retainer 13 is mounted in the retainer mounting recess portion 11i so as to be laterally movable between a preset position which is offset to the right in front view and a set position which is offset to the left in front view. In FIG. 2, A2 represents a direction in which the retainer 13 is moved toward the preset position while A3 represents a direction in which the retainer 13 is moved toward the set position.

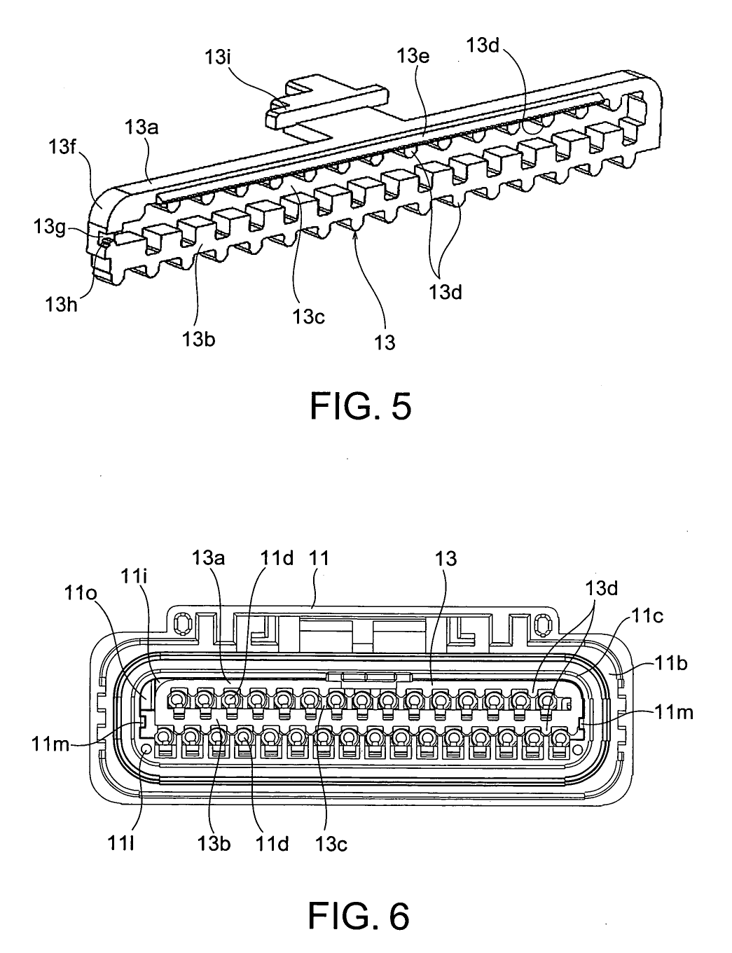

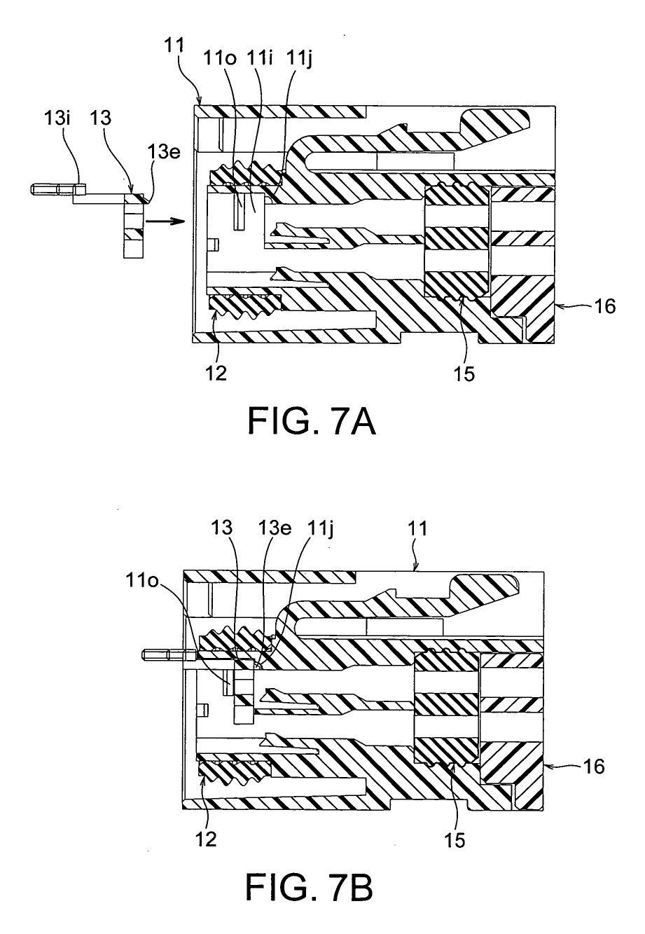

Referring further to FIGS. 5 and 7A-7B, the retainer 13 has a laterally long frame shape and is mounted in the retainer mounting recess portion 11i so that an upper frame portion 13a is located above the upper-row terminal receiving holes 11d, that a lower frame portion 13b is located between the upper-row terminal receiving holes 11d and the lower-row terminal receiving holes 11d, that a space 13c between the upper frame portion 13a and the lower frame portion 13b faces the upper-row terminal receiving holes 11d, and that a laterally long guide protrusion 13e formed on a rear face of the upper frame portion 13a is inserted into a laterally long guide groove 11j formed in the bottom surface of the retainer mounting recess portion 11i, thereby laterally guiding the retainer 13 between the preset position and the set position while the guide protrusion 13e is received in the guide groove 11j.

Further, at the lower edges of the upper and lower frame portions 13a and 13b of the retainer 13, projections 13d are formed at the same pitches as those of the upper- and lower-row terminal receiving holes 11d, respectively. As best shown in FIGS. 6 and 10A to 14C, the projections 13d retreat to the sides of the terminal receiving holes 11d, respectively, when the retainer 13 is at the preset position while the projections 13d project into the terminal receiving holes 11d, respectively, when the retainer 13 is moved to the set position.

In the middle of the upper frame portion 13a of the retainer 13, an operating portion 13i for the operation of laterally moving the retainer 13 is formed so as to project forward.

As shown in FIGS. 4A to 5 and 12A to 14C, a positioning mechanism for positioning and holding the retainer 13 selectively at the preset position and at the set position is provided between the retainer 13 and the retainer mounting recess portion 11i. Specifically, a locking arm 11k which is vertically flexible is protruded at the bottom of the retainer mounting recess portion 11i on its right end side while a laterally long escape groove 13g where the locking arm 11k enters is formed in a rear face of a right frame portion 13f of the retainer 13 and a locking dowel 13h is formed in the escape groove 13g at its lower surface. With this structure, when the locking dowel 13h is moved, due to lateral movement of the retainer 13, selectively to the right and to the left of the locking arm 11k while bending the locking arm 11k upward, so as to engage with the locking arm 11k, the retainer 13 is positioned and held selectively at the preset position and at the set position.

As shown in FIGS. 6 to 7B, a left side wall of the retainer mounting recess portion 11i is provided at its inner surface with a guide projection 110 which is brought into contact with a left end of the retainer 13 so as to guide the retainer 13 to the preset position when incorporating the retainer 13 into the retainer mounting recess portion 11i. When moving the retainer 13 to the set position, the left end of the retainer 13 enters a space between the bottom of the retainer mounting recess portion 11i and the guide projection 110 as shown in FIG. 7B so that the guide projection 110 does not impede lateral movement of the retainer 13.

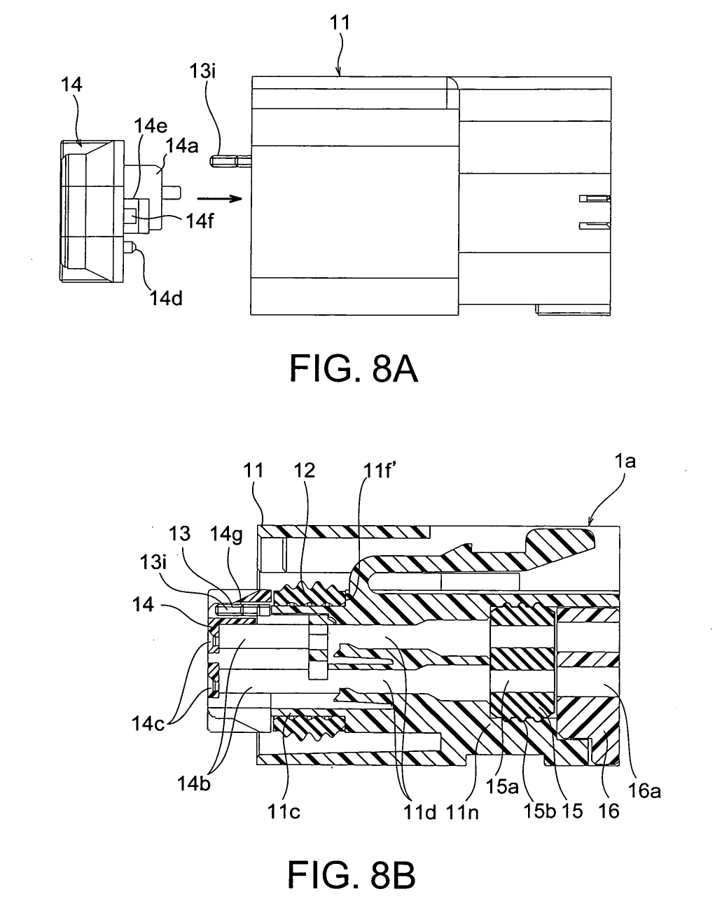

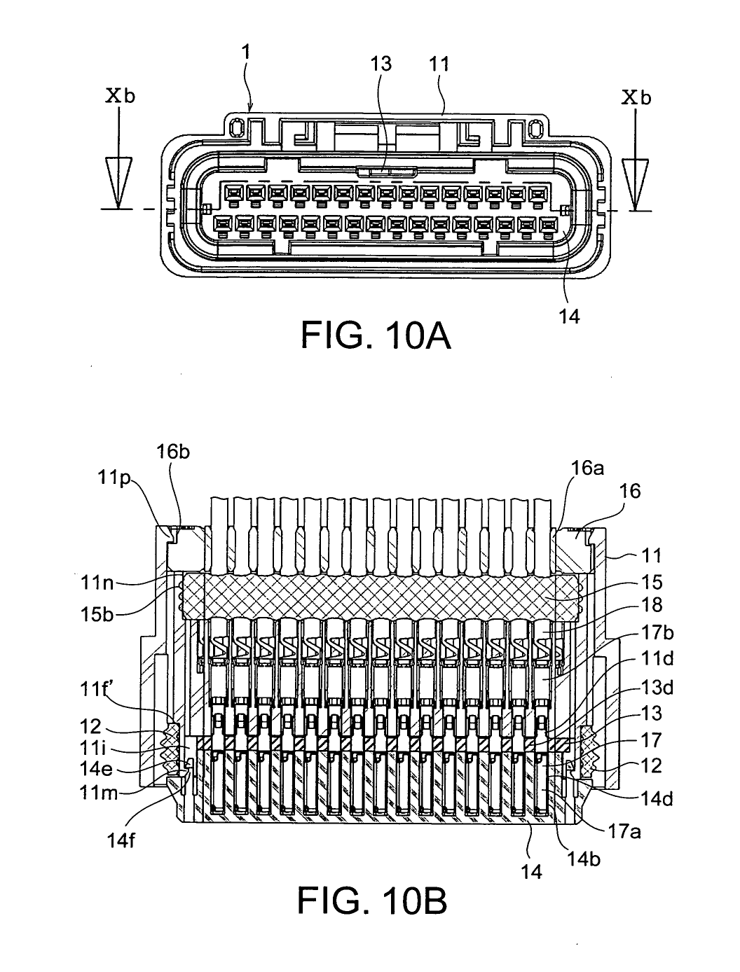

As shown in FIG. 8B, the front cap 14 for holding the retainer 13 is fixedly attached to the fitting portion 11c at its front end face. The front cap 14 has a rectangular plate-like shape with an outer shape substantially the same as that of the fitting portion 11c. The front cap 14 is fixed to the front end face of the fitting portion 11c by press-fitting positioning projections 14d (see FIG. 8A) provided at lower corners on both sides of a rear face of the front cap 14 into positioning holes 11l(see FIG. 6) provided at lower corners on both sides of the front end face of the fitting portion 11c and further, as shown in FIG. 10B, by engaging locking holes 14f of ]-shaped locking pieces 14e (see also FIG. 8A) projecting at both ends of the rear face of the front cap 14 with locking projections 11m (see also FIGS. 4A and 6) provided at both side inner surfaces of the retainer mounting recess portion 11i. By fixing the front cap 14 in this manner, the seal member 12 is held so as to be sandwiched between a rear face peripheral edge portion of the front cap 14 and a rear stepped face 11f′ of the seal member mounting portion 11f.

As shown in FIGS. 8A and 12A to 12C, the front cap 14 has, at its rear face, a laterally long block-like projecting portion 14a which is received in the retainer mounting recess portion 11i so that the retainer 13 is held so as to be sandwiched between the projecting portion 14a and the bottom of the retainer mounting recess portion 11i. As shown in FIGS. 2 and 8B, a front end of the operating portion 13i of the retainer 13 is exposed at a front face of the front cap 14 through a retainer operating portion insertion hole 14g, thereby allowing the operation for lateral movement of the retainer 13.

As shown in FIGS. 8B and 12A to 12C, the rear face of the front cap 14 and a rear face of the projecting portion 14a are formed with additional terminal receiving holes 14b which communicate with the upper- and lower-row terminal receiving holes 11d of the fitting portion 11c, respectively, and front end portions of the terminal receiving holes 14b are opened at the front face of the front cap 14 so as to serve as mating terminal insertion holes 14c. An outer peripheral surface of the front cap 14 is formed as a tapered surface for facilitating fitting to the mating connector 2.

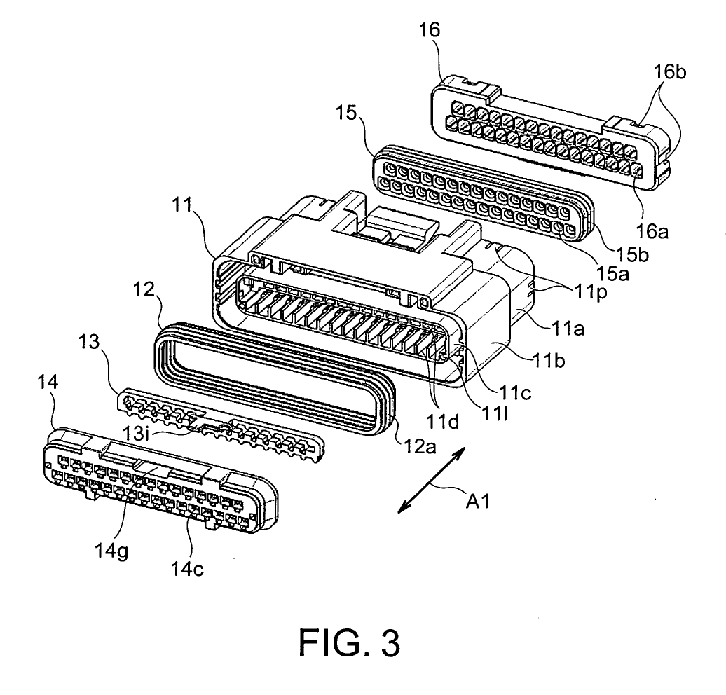

As shown in FIGS. 8B and 10B, the cable seal member 15 and the rear cover 16 are fixedly mounted in the cable seal member mounting recess 11n at the rear end face of the connector body 11a. As shown in FIG. 3, the cable seal member 15 has a rectangular plate-like shape and is formed with cable insertion holes 15a which communicate with the terminal receiving holes 11d, respectively, and further formed on its outer periphery with sealing protrusions 15b which are in tight or close contact with an inner periphery of the cable seal member mounting recess 11n for sealing. As shown in FIG. 3, the rear cover 16 has a rectangular plate-like shape and is formed with cable insertion holes 16a which communicate with the cable insertion holes 15a of the cable seal member 15, respectively. As shown in FIGS. 8B and 10B, the rear cover 16 is mounted in the cable seal member mounting recess 11n so as to be in abutment with the cable seal member 15 and is fixed by engaging locking claws 11p (see also FIG. 3) provided at a rear end edge of the cable seal member mounting recess 11n with locking recesses 16b provided at a rear end edge of the rear cover 16.

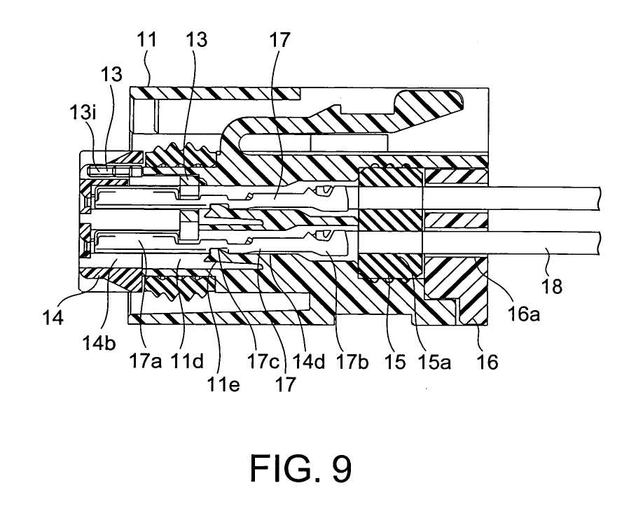

As shown in FIG. 9, each terminal 17 has a box-shaped contact portion 17a at its front end and a cable crimping portion 17b at its rear end. After cables 18 are crimped to the cable crimping portions 17b, the terminals 17 are inserted into the terminal receiving holes 11d and 14b of a connector assembly 1a (see FIG. 8B) comprising the housing 11, the seal member 12, the retainer 13, the front cap 14, the cable seal member 15, and the rear cover 16 through the cable insertion holes 16a and 15a in the preset state of the retainer 13.

In this event, as shown in FIGS. 9, 10A-10B, and 12A to 12C, since the retainer 13 is at the preset position and thus the projections 13d are at the positions retreated to the sides of the terminal receiving holes 11d and 14b, the terminals 17 are inserted deeply into the terminal receiving holes 11d and 14b and, when each terminal 17 abuts against a deep end face being a boundary with the mating terminal insertion hole 14c, a lance 11e provided on an inner periphery of the terminal receiving hole 11d enters a locking hole 17c provided at an intermediate portion of the terminal 17 so that the terminal 17 is primarily locked in a come-off preventing state.

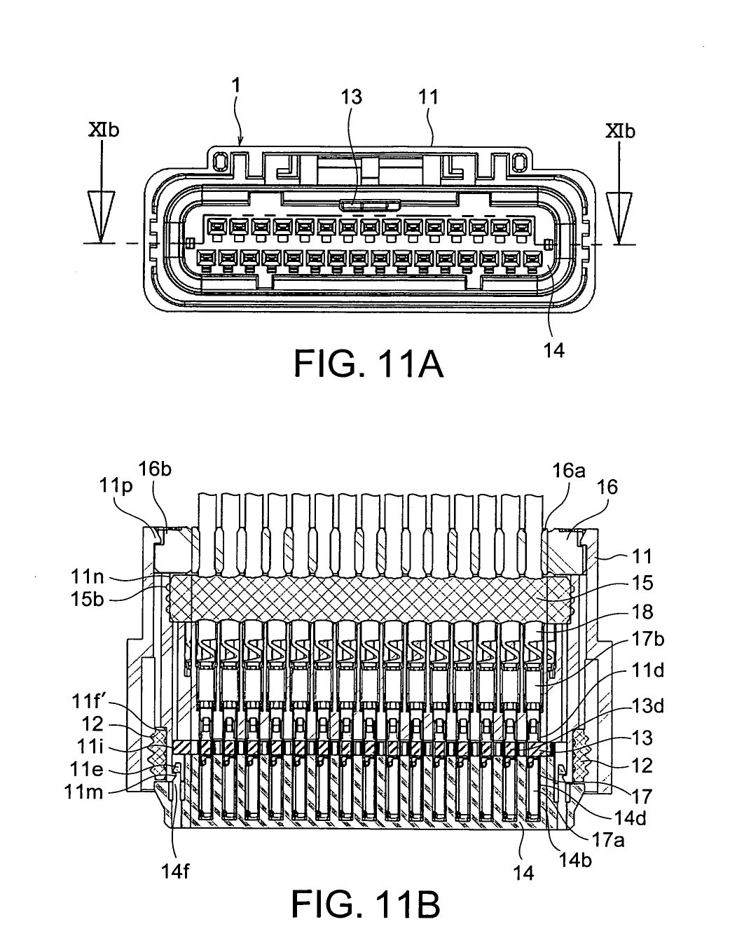

Thereafter, the retainer 13 is laterally moved to the set position from the preset position by operating the operating portion 13i from the front side of the front cap 14. Then, as shown in FIGS. 11A-11B, 14A to 14C, and 15, the projections 13d of the retainer 13 project into the terminal receiving holes 11d and 14b so that each projection 13d engages with a rear end face of the box-shaped contact portion 17a, thereby secondarily locking the terminal 17 in a come-off preventing state.

In this manner, the terminals 17 are double locked to the housing 11 and thus are firmly held in the come-off preventing state. Further, in this event, an inner periphery of each cable insertion hole 15a of the cable seal member 15 is brought into tight or close contact with an outer periphery of the cable 18 inserted into the cable insertion hole 15a and, as described above, the sealing protrusions 15b on the outer periphery of the cable seal member 15 are in tight or close contact with the inner periphery of the cable seal member mounting recess 11n, thereby sealing between the cables 18 and the housing 11. In this manner, the waterproof connector 1 is completed.

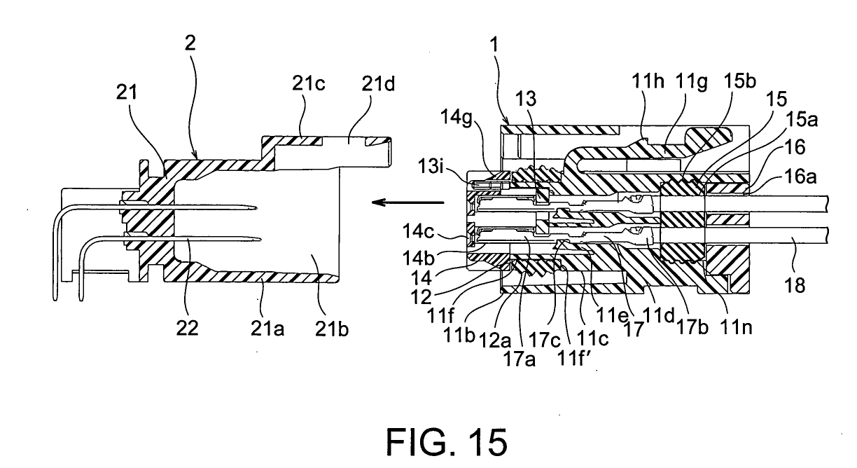

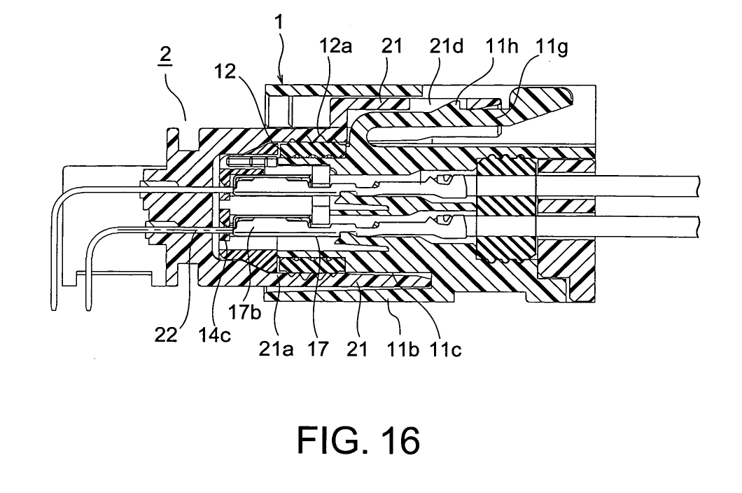

FIG. 15 is a longitudinal cross-sectional view showing a state before fitting of the waterproof connector 1 to the mating connector 2 and FIG. 16 is a longitudinal cross-sectional view showing a state after the fitting.

Referring to FIGS. 15 and 16, the mating connector 2 comprises a housing 21 of a bottomed hollow rectangular parallelepiped shape having a fitting tubular portion 21a with a fitting hole 21b which is opened forward, and a plurality of pin terminals 22 which pass through and are held by the bottom of the fitting hole 21b, wherein the fitting tubular portion 21a is provided, at its upper wall portion on the front end side, with a locking piece 21c which is bulged upward and projects forward.

When the fitting tubular portion 21a of the mating connector 2 is inserted into a space between the fitting portion 11c and the hood portion 11b of the waterproof connector 1, the fitting portion 11c of the waterproof connector 1 enters the fitting hole 21b of the mating connector 2 so that the pin terminals 22 enter the box-shaped contact portions 17a of the terminals 17 in the fitting portion 11c through the mating terminal insertion holes 14c so as to be in contact with the terminals 17, thereby electrically connecting the waterproof connector 1 and the mating connector 2 to each other. Further, sealing protrusions 12a of the seal member 12 disposed on the outer periphery of the fitting portion 11c are brought into tight or close contact with an inner periphery of the fitting tubular portion 21a, thereby achieving waterproofing between the waterproof connector 1 and the mating connector 2. Further, a locking hole 21d provided in the locking piece 21c of the mating connector 2 engages with a locking projection 11h of the locking arm 11g of the waterproof connector 1, thereby locking the fitting state of the connectors 1 and 2.

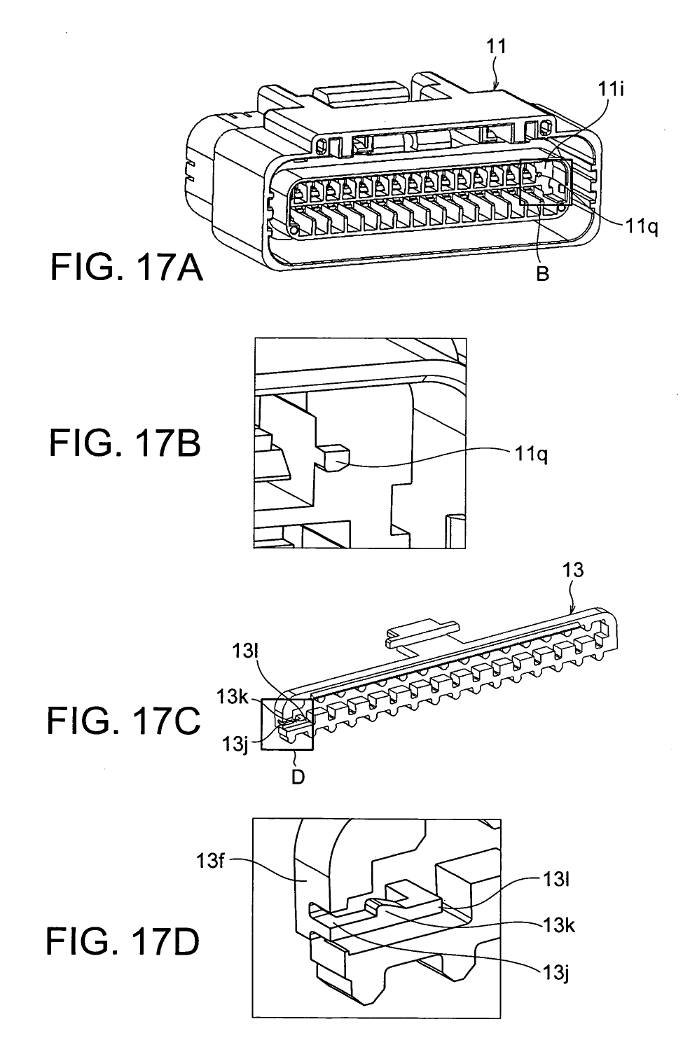

FIGS. 17A to 17D show a modification of the positioning mechanism for positioning and holding the retainer 13 selectively at the preset position and at the set position.

In this modification, a locking dowel 11q is formed at the bottom of a retainer mounting recess portion 11i on its right end side while a laterally long groove space 13j where the locking dowel 11q enters is formed in a rear face of a right frame portion 13f of a retainer 13 and a locking arm 13I extending laterally, being vertically flexible, and having a locking projection 13k at its upper surface is formed in the groove space 13j. With this structure, when the locking projection 13k is moved, due to lateral movement of the retainer 13, selectively to the right and to the left of the locking dowel 11q while bending the locking arm 13l downward, so as to engage with the locking dowel 11q, the retainer 13 is positioned and held selectively at the preset position and at the set position.

According to the waterproof connector 1 described above, since the outer periphery of the fitting portion 11c has no opening for inserting the retainer 13, the retainer 13 and the seal member 12 can be disposed at positions overlapping each other in the front-rear direction A1 and therefore the overall length of the waterproof connector 1 can be made short.

In the conventional waterproof connector, since the outer periphery of the fitting portion has the opening for inserting the retainer, there is no alternative but to mount the seal member on the outer periphery of the fitting portion at the position rearward of the opening so that the overall length of the connector is prolonged correspondingly. In particular, generally, in order to provide a double locking mechanism of terminal holding by a resin lance (primary locking) and terminal holding by a retainer (secondary locking), male and female connectors should each have a retainer insertion opening forward (i.e. on the mating connector side) of a waterproof range which is involved in waterproofing between both housings. Therefore, when a slide-type preset retainer is applied to the conventional waterproof connector, the position of the waterproof surface should be retreated corresponding to the thickness of the retainer and thus the overall length of the connector is prolonged correspondingly.

In contrast, according to the embodiment of this invention, the overall length of the waterproof connector, having the waterproofing seal member disposed on the outer periphery of the fitting portion and having the terminal-locking lateral slide-type retainer incorporated in the fitting portion, can be designed to be short. That is, the retainer is incorporated so as to be operable from the front end face of the fitting portion, no opening is provided for incorporating the retainer from the outer periphery of the fitting portion, and the seal member and the retainer are disposed at the positions overlapping each other in the fitting direction, thereby enabling shortening of the overall length of the connector.

Further, by incorporating the retainer inward of the waterproof surface of the housing and projecting only the portion, for manually performing the slide operation of the retainer, forward (on the mating connector side) of the waterproof range, no retainer incorporation opening is required at the outer periphery of the housing. Therefore, the layout of the positions of the important functions such as the waterproof range and the locking mechanism can be freely carried out.

Various exemplary embodiments of this invention will be enumerated in the following items 1-12.

1. A waterproof connector 1 comprising:

a housing 11 including a fitting portion 11c which is adapted to be fitted into a fitting hole 21b of a mating connector 2 in a fitting direction, the fitting portion having a terminal receiving hole 11d which penetrates the fitting portion in the fitting direction;

a terminal 17 to be received in the terminal receiving hole;

a retainer 13 which is assembled in the fitting portion so as to be movable between a preset position and a set position in a direction crossing the terminal receiving hole; and

a seal member 12 which is attached to an outer periphery of the fitting portion and is adapted to be brought into close contact with an inner periphery of the fitting hole for sealing when the fitting portion is fitted to the fitting hole;

wherein the retainer has a projection 13d which retreats to a side of the terminal receiving hole to allow insertion of the terminal into the terminal receiving hole when the retainer is at the preset position and which projects into the terminal receiving hole to engage with the terminal so as to hold the terminal in the terminal receiving hole when the retainer is at the set position, and the retainer and the seal member are provided at positions which overlap each other in the fitting direction.

2. The waterproof connector according to item 1, further comprising:

a retainer mounting recess portion 11i which is formed in a front end face of the fitting portion; and

a front cap 14 which is formed with an additional terminal receiving hole 14b communicating with the terminal receiving hole of the fitting portion and is attached to the front end face of the fitting portion,

wherein the retainer is received in the retainer mounting recess portion and sandwiched between a bottom of the retainer mounting recess portion and the front cap.

3. The waterproof connector according to item 2, wherein the retainer comprises an operating portion 13i which is exposed at a front end face of the front cap through a retainer operating portion insertion hole 14g provided in the front cap, thereby allowing operation for lateral movement of the retainer.

4. The waterproof connector according to item 3, further comprising a positioning mechanism for positioning and holding the retainer selectively at the preset position and at the set position.

5. The waterproof connector according to item 4, wherein the positioning mechanism comprises:

a locking dowel 13h provided at one of the retainer mounting recess portion and the retainer; and

a locking arm 13l provided at the other of the retainer mounting recess portion and the retainer,

wherein the locking arm is moved to elastically ride over the locking dowel due to lateral movement of the retainer so as to be locked on both sides of the locking dowel, respectively.

6. The waterproof connector according to item 5, further comprising a stepped-down mounting portion 11f formed on the outer periphery of the fitting portion at its front end portion, wherein the seal member is mounted on the stepped-down mounting portion and held so as to be sandwiched between a rear stepped face of the seal member mounting portion and a rear face peripheral edge portion of the front cap.

7. The waterproof connector according to item 1, wherein the terminal has a locking hole 17c, the terminal receiving hole has an inner periphery which is provided with a lance 11e, the terminal is primarily locked by engagement of the lance into the locking hole caused by insertion of the terminal into the terminal receiving hole, and the terminal is secondarily locked by moving the retainer from the preset position to the set position.

8. The waterproof connector according to item 2, wherein the terminal has a locking hole 17c, the terminal receiving hole has an inner periphery which is provided with a lance 11e, the terminal is primarily locked by engagement of the lance into the locking hole caused by insertion of the terminal into the terminal receiving hole, and the terminal is secondarily locked by moving the retainer from the preset position to the set position.

9. The waterproof connector according to item 3, wherein the terminal has a locking hole 17c, the terminal receiving hole has an inner periphery which is provided with a lance 11e, the terminal is primarily locked by engagement of the lance into the locking hole caused by insertion of the terminal into the terminal receiving hole, and the terminal is secondarily locked by moving the retainer from the preset position to the set position.

10. The waterproof connector according to item 4, wherein the terminal has a locking hole 17c, the terminal receiving hole has an inner periphery which is provided with a lance 11e, the terminal is primarily locked by engagement of the lance into the locking hole caused by insertion of the terminal into the terminal receiving hole, and the terminal is secondarily locked by moving the retainer from the preset position to the set position.

11. The waterproof connector according to item 5, wherein the terminal has a locking hole 17c, the terminal receiving hole has an inner periphery which is provided with a lance 11e, the terminal is primarily locked by engagement of the lance into the locking hole caused by insertion of the terminal into the terminal receiving hole, and the terminal is secondarily locked by moving the retainer from the preset position to the set position.

12. The waterproof connector according to item 6, wherein the terminal has a locking hole 17c, the terminal receiving hole has an inner periphery which is provided with a lance 11e, the terminal is primarily locked by engagement of the lance into the locking hole caused by insertion of the terminal into the terminal receiving hole, and the terminal is secondarily locked by moving the retainer from the preset position to the set position.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A waterproof connector comprising:
a housing including a fitting portion which is adapted to be fitted into a fitting hole of a mating connector in a fitting direction, the fitting portion having a terminal receiving hole which penetrates the fitting portion in the fitting direction;
a terminal to be received in the terminal receiving hole;
a retainer which is assembled in the fitting portion so as to be movable between a preset position and a set position in a direction crossing the terminal receiving hole; and
a seal member which is attached to an outer periphery of the fitting portion and is adapted to be brought into close contact with an inner periphery of the fitting hole for sealing when the fitting portion is fitted to the fitting hole;
wherein the retainer has a projection which retreats to a side of the terminal receiving hole to allow insertion of the terminal into the terminal receiving hole when the retainer is at the preset position and which projects into the terminal receiving hole to engage with the terminal so as to hold the terminal in the terminal receiving hole when the retainer is at the set position, and the retainer and the seal member are provided at positions which overlap each other in the fitting direction.

2. The waterproof connector according to claim 1, further comprising:
a retainer mounting recess portion which is formed in a front end face of the fitting portion; and
a front cap which is formed with an additional terminal receiving hole communicating with the terminal receiving hole of the fitting portion and is attached to the front end face of the fitting portion,
wherein the retainer is received in the retainer mounting recess portion and sandwiched between a bottom of the retainer mounting recess portion and the front cap.

3. The waterproof connector according to claim 2, wherein the retainer comprises an operating portion which is exposed at a front end face of the front cap through a retainer operating portion insertion hole provided in the front cap, thereby allowing operation for lateral movement of the retainer.

4. The waterproof connector according to claim 3, further comprising a positioning mechanism for positioning and holding the retainer selectively at the preset position and at the set position.

5. The waterproof connector according to claim 4, wherein the positioning mechanism comprises:
a locking dowel provided at one of the retainer mounting recess portion and the retainer; and
a locking arm provided at the other of the retainer mounting recess portion and the retainer,
wherein the locking arm is moved to elastically ride over the locking dowel due to lateral movement of the retainer so as to be locked on both sides of the locking dowel, respectively.

6. The waterproof connector according to claim 5, further comprising a stepped-down mounting portion formed on the outer periphery of the fitting portion at its front end portion, wherein the seal member is mounted on the stepped-down mounting portion and held so as to be sandwiched between a rear stepped face of the seal member mounting portion and a rear face peripheral edge portion of the front cap.

7. The waterproof connector according to claim 1, wherein the terminal has a locking hole, the terminal receiving hole has an inner periphery which is provided with a lance, the terminal is primarily locked by engagement of the lance into the locking hole caused by insertion of the terminal into the terminal receiving hole, and the terminal is secondarily locked by moving the retainer from the preset position to the set position.

8. The waterproof connector according to claim 2, wherein the terminal has a locking hole, the terminal receiving hole has an inner periphery which is provided with a lance, the terminal is primarily locked by engagement of the lance into the locking hole caused by insertion of the terminal into the terminal receiving hole, and the terminal is secondarily locked by moving the retainer from the preset position to the set position.

9. The waterproof connector according to claim 3, wherein the terminal has a locking hole, the terminal receiving hole has an inner periphery which is provided with a lance, the terminal is primarily locked by engagement of the lance into the locking hole caused by insertion of the terminal into the terminal receiving hole, and the terminal is secondarily locked by moving the retainer from the preset position to the set position.

10. The waterproof connector according to claim 4, wherein the terminal has a locking hole, the terminal receiving hole has an inner periphery which is provided with a lance, the terminal is primarily locked by engagement of the lance into the locking hole caused by insertion of the terminal into the terminal receiving hole, and the terminal is secondarily locked by moving the retainer from the preset position to the set position.

11. The waterproof connector according to claim 5, wherein the terminal has a locking hole, the terminal receiving hole has an inner periphery which is provided with a lance, the terminal is primarily locked by engagement of the lance into the locking hole caused by insertion of the terminal into the terminal receiving hole, and the terminal is secondarily locked by moving the retainer from the preset position to the set position.

12. The waterproof connector according to claim 6, wherein the terminal has a locking hole, the terminal receiving hole has an inner periphery which is provided with a lance, the terminal is primarily locked by engagement of the lance into the locking hole caused by insertion of the terminal into the terminal receiving hole, and the terminal is secondarily locked by moving the retainer from the preset position to the set position.
